(19) United States
(12) Patent Application Publication
(10) Pub. No.: US 2017/0049074 A1
(43) Pub. Date: Feb. 23, 2017

(54) Animal Identification Systems

(71) Applicant: Aleis Pty Ltd, Jandowae, Queensland (AU)

(72) Inventors: Benjamin Thomas John Wilkinson, Redland Bay, Queensland (AU); Brian Antony Clayton, Burpengary, Queensland (AU); Frank John Finlayson, Aramac, Queensland (AU); Patrick Bernard Gunston, Mount Gravatt East, Queensland (AU)

(73) Assignee: Aleis Pty Ltd, Jandowae, Queensland (AU)

(21) Appl. No.: 15/308,060

(22) PCT Filed: Apr. 30, 2015
(86) PCT No.: PCT/AU2015/050208

§ 371 Date: Oct. 31, 2016

Related U.S. Application Data
(60) Provisional application No. 61/987,329, filed on May 1, 2014.

(51) Int. Cl. A01K 11/00

(52) U.S. Cl. CPC A01K 11/004

(57) ABSTRACT

An animal identification system, including: a race including a pair of opposed walls between which, in use, animals pass, and a floor including one or more steps or sloping sections defining a height change; one or more readers configured to read electronic animal identification devices borne by animals passing along the race; wherein, at least one of the one or more readers is positioned beneath, on top of or within the floor at or near the height change such that, in use, movement of the animals caused by the height change tends to bring the animals' identification devices into closer proximity to that reader.

### FIELD OF THE INVENTION

The invention relates to animal identification systems, in particular to systems arranged to read electronic identification devices borne by animals as the animals pass along a race.

### BACKGROUND TO THE INVENTION

Electronic identification (EID) systems are now commonly used in agricultural applications. In particular EID ear tags, anklet tags, intra-ruminal devices, implants and the like are carried by many animals, and those animals can be individually identified by reading the EID device.

EID readers may be incorporated in a race system, for example as disclosed in Allflex Australia Pty Ltd's U.S. Pat. No. 8,154,465. That system includes a portal antenna positioned at a mid point of a race, such that animals passing along the race will also pass through the antenna structure.

It would be desirable to improve the performance of prior ID reader systems, by improvement of ease of use, the accuracy of ID reads collected, increasing the number of reads possible over a time period, or reduction of the number of missed reads.

Reference to any prior art in this specification does not constitute an admission that such prior art forms part of the common general knowledge.

It is an object of the invention to provide an improved animal identification system, or at least to provide the public with a useful choice.

### SUMMARY OF THE INVENTION

In a first aspect the invention provides an animal identification system, including: a race including a pair of opposed walls between which, in use, animals pass, and a floor including one or more steps or sloping sections defining a height change; one or more readers configured to read electronic animal identification devices borne by animals passing along the race; wherein, at least one of the one or more readers is positioned beneath, on top of or within the floor at or near the height change such that, in use, movement of the animals caused by the height change tends to bring the animals' identification devices into closer proximity to that reader and wherein the animal identification devices are borne by the animals' heads and the height change causes animals to drop their heads.

Preferably the height change is defined by an upwardly sloping ramp.

Preferably the animal identification devices are borne by the animals' heads and the height change causes animals to drop their heads.

Preferably the system includes at least two readers positioned beneath, on top of or within the floor and being oriented at different angles with respect to a vertical plane.

In another aspect the invention provides an animal identification system, including: a race including a pair of opposed walls between which, in use, animals pass; and one or more readers configured to read electronic animal identification devices borne by animals passing along the race; wherein the race has a structure that causes animals to move within the race such that identification devices borne by the animals are moved in a non-linear manner through the race, this non-linear movement tending to bring the animals' animal identification devices into closer proximity to at least one of the one or more readers and wherein the location of the one or more readers with respect to the structure is configured to substantially maximize successful identification device reads by the one or more readers.

Optionally the at least one of the one or more readers is positioned on one of the opposed walls and the race structure is configured to cause sideways movement of the animals as they pass along the race.

Optionally the race structure includes one or more includes one or more projections, curves or undulations configured to cause the sideways movement.

Optionally the animal identification devices are borne by the animals' heads and the sideways movement is sideways movement of the animals' heads.

Preferably the race structure includes one or more includes one or more steps or sloping sections defining a height change, configured to cause vertical movement of the animal's heads as they pass along the race.

Preferably at least one of the one or more readers is positioned beneath, on top of or within the floor at or near the height change such that, in use, movement of the animals caused by the height change tends to bring the animals' identification devices into closer proximity to that reader.

Preferably the height change is defined by an upwardly sloping ramp.

Preferably the animal identification devices are borne by the animals' heads and the height change causes animals to drop their heads.

Preferably the system includes at least two readers positioned beneath, on top of or within the floor and being oriented at different angles.

Preferably the pair of opposed walls define one or more undulations.

Optionally the pair of opposed side walls define a single undulation.

Optionally the race has a generally U, C or V shape.

Preferably the pair of opposed side walls define two or more undulations.

Preferably the race has a generally S, Z or W shape.

Optionally the undulations define a continuous curved surface.

Alternatively the undulations define a discontinuous surface with a number of substantially planar sections arranged at an angle to each other.

Preferably the length of each undulation is between 0.5 and 2 times the average body length of the animals to be identified.

Preferably the length of each undulation is between 0.7 and 1.5 times the average body length of the animals to be identified.

In a further aspect the invention provides an animal identification system including: a race including a pair of opposed walls between which, in use, animals pass, the pair of opposed walls defining one or more undulations; and a plurality of ID readers positioned about the undulations to read animal ID devices borne by animals passing along the path.

Optionally the pair of opposed side walls define a single undulation.

Optionally the race has a generally U, C or V shape.

Preferably the pair of opposed side walls define two or more undulations.

Preferably the race has a generally S, Z or W shape.

Optionally the undulations define a continuous curved surface.

Alternatively the undulations define a discontinuous surface with a number of substantially planar sections arranged at an angle to each other.

Preferably the length of each undulation is between 0.5 and 2 times the average body length of the animals to be identified.

Preferably the length of each undulation is between 0.7 and 1.5 times the average body length of the animals to be identified.

In another aspect the invention provides an animal identification system, including: a race including a pair of opposed walls defining a path along which, in use, animals pass; one or more readers configured to read electronic animal identification devices borne by animals passing along the path through the race; wherein the opposed walls include at least one angled wall portion that is non-parallel with the path, and wherein at least one reader is mounted on the angled wall portion such that the reader is positioned at an acute angle to the path and wherein the location of the one or more readers with respect to the structure is configured to substantially maximize successful identification device reads by the one or more readers.

Preferably the race is at least 1.5 metres in length.

Preferably the race is at least 2.5 metres in length.

Preferably the opposing walls are arranged at an angle to the ground, such that the race is narrower at ground level than at a higher point.

Preferably at least some of the ID readers are positioned on the opposing walls.

Preferably at least some of the ID readers are oriented at different angles to each other.

Preferably the animal identification devices are ear tags.

Alternatively the animal identification devices are animal intra-ruminal devices, implants, or similar devices.

### BRIEF DESCRIPTION OF THE DRAWINGS

The invention will now be described by way of example only, with reference to the accompanying drawings, in which:

FIG. 1 shows an animal identification system according to one embodiment;

FIG. 2 shows a floor profile according to one embodiment;

FIG. 3 shows a floor profile according to a further embodiment;

FIG. 4 shows a floor profile according to another embodiment;

FIG. 5 shows a floor profile according to a further embodiment;

FIG. 6 shows an animal identification system according to another embodiment;

FIG. 7 shows an animal identification system according to a further embodiment;

FIG. 8 shows a wall profile according to one embodiment;

FIG. 8A shows a wall profile according to a further embodiment;

FIG. 8B shows a wall profile according to another embodiment;

FIG. 9 shows a wall profile according to a further embodiment;

FIG. 9A shows a wall profile according to another embodiment;

FIG. 9B shows a wall profile according to a further embodiment;

FIG. 10 shows a wall profile according to another embodiment;

FIG. 11 shows a wall profile according to a further embodiment;

FIG. 12 shows a wall profile according to another embodiment;

FIG. 13 shows a wall profile according to a further embodiment; and

FIG. 14 shows an animal identification system according to another embodiment.

### DETAILED DESCRIPTION

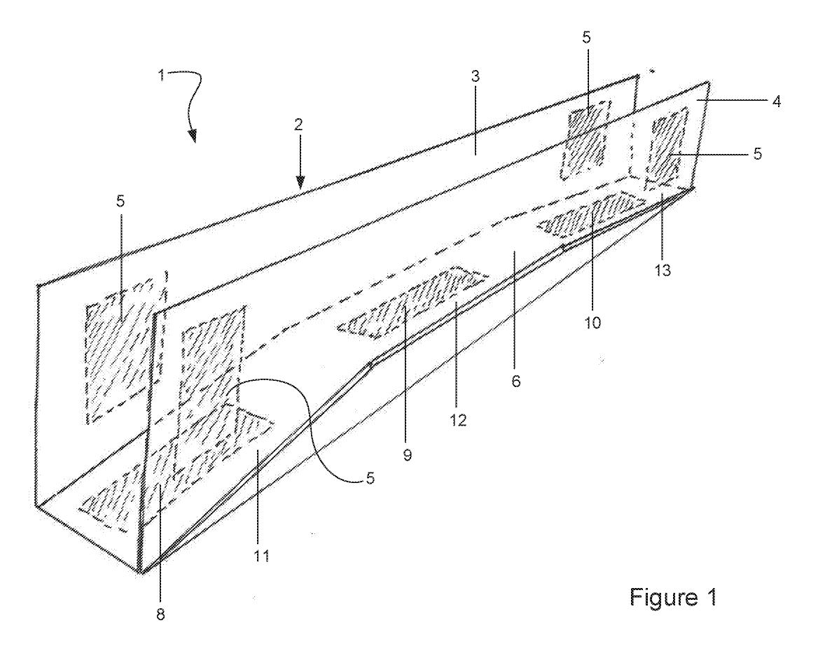

FIGS. 1 to 5 illustrate embodiments of animal identification reader systems which use a height change, slope or step in the race in order to improve performance of the identification system.

FIG. 1 shows an identification system 1 including an animal race 2 defined by a pair of opposing walls 3, 4. The system 1 also includes a number of ID readers configured to read identification devices borne by animals passing along the race 2. The ID readers may include one or more ID readers 5 (marked schematically in FIG. 1) either built into the wall, or attached to the inside, or attached to the outside of the opposing walls 3, 4. Further, one or more ID readers 8, 9, 10 may be built into the floor 6, or positioned beneath the floor 6 of the race 2.

As shown in FIG. 1, in this embodiment the floor 6 is not a flat floor. Rather, the floor includes a first upwardly sloping ramp section 11, a flat section 12 and a downwardly sloping ramp section 13. In a preferred embodiment at least one ID reader 8, 9, 10 is positioned beneath each of these three sections 11, 12, 13 of floor 6.

In preferred embodiments, at least one ID reader is positioned at or near a height change in the floor 6. For example, in the embodiment of FIG. 1 the ID reader 8 is positioned beneath the upwardly sloping ramp section 11 of floor 6. As an animal passes along the race 2, the upwards slope tends to cause the animal to drop its head. An animal identification device borne on the animal's head (for example an ear tag or an implant somewhere on the animal's head) will therefore move downwards, closer to the ID reader 8. In other words, the structure of the race tends to cause movement of the animal so as to bring the identification device into closer proximity to the ID reader. This has the result of improving the quality of reading of the identification device by the ID reader 8.

As shown in FIG. 1, the readers 5, 8, 9, 10 are mounted on the floor 6 and walls 3, 4 of the race 2. Further, the system is preferably free of overhead structures, such as the beams, overhead antenna structures and the like used in some prior systems. The race is therefore open to the top, and this is believed to improve flow of animals through the race, and also allows better access to the race for workers and working dogs etc. In use, farm workers can easily walk along the race or lean over the top of the walls 3, 4 without being impeded by the structure of the race or the reader system.

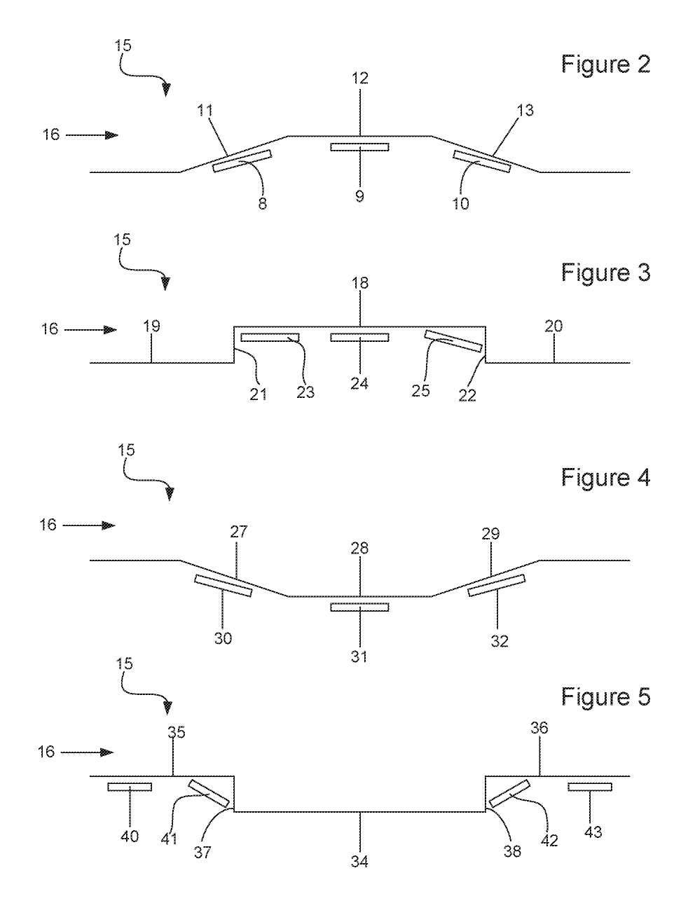

FIGS. 2 to 4 each show a possible floor profile 15, viewed from the side and with the opposing walls 3, 4 omitted for clarity. FIG. 2 shows a profile similar to that of FIG. 1, with a first upwardly sloping ramp section 11, a flat section 12 and a downwardly sloping ramp section 13, with an ID reader 8, 9, 10 positioned beneath each of these three sections 11, 12, 13 of floor 6. As shown, the ID readers 8 and 10 may be either built into, or attached to the top, or attached to the underside of the sloping ramp sections 11, 12, 13, or to any suitable supporting structure. This presents the ID reader at an angle to the vertical, which creates further diversity in the read system. Thus, the first antenna 8 is at an angle to both vertical and horizontal, back towards the entrance 16 of the race 2. The second antenna 9 is mounted beneath the flat section 12 of floor 6 and therefore points directly upwards.

The third antenna 10 is mounted beneath the downwardly sloping ramp section 13 and is at an angle to both vertical and horizontal, away from the entrance 16 of the race 2.

These different angles create diversity in the reader system, providing different possibilities for the read antennas to pick up signals from animal identification devices. In general it will be enough for each animal identification device to be read successfully by one antenna as it is borne along the race.

FIG. 3 shows a further floor profile 15, with a raised floor section 18 positioned between two lowered or ground level sections 19, 20. The raised floor section 18 is defined by upwards and downwards steps 21, 22. ID readers 23, 24, 25 may be mounted beneath the raised floor section 18, either directly to the underside of the floor or on some other supporting structure. The ID readers may be arranged horizontally, as shown for ID readers 23, 24, or supported on an angle, as shown for ID reader 25.

FIG. 4 shows a further floor profile 15, with a first downwardly sloping ramp section 27, a flat section 28 and an upwardly sloping ramp section 29, with an ID reader 30, 31, 32 positioned beneath each of these three sections 27, 28, 29 of floor 6. Again, the ID readers may be attached to the underside of the floor, or to any suitable supporting structure.

FIG. 5 shows another floor profile 15, with a lowered floor section 34 positioned between two raised sections 35, 36. The lowered floor section 34 is defined by downwards and upwards steps 37, 38. ID readers 40, 41, 42, 43 may be mounted beneath the raised floor sections 35, 36, either directly to the underside of the floor or on some other supporting structure. The ID readers may be vertical, as shown for ID readers 40, 43, or supported on an angle, as shown for ID readers 41, 42.

In general, a floor having one or more steps, slopes or height changes will cause an animal to move along the race in such a manner that its does not follow a horizontal, linear path along the race. An ID reader can be appropriately positioned such that the movement caused brings the identification device into closer proximity to the ID reader.

Embodiments using ramps rather than steps are preferred, as these will create the minimum impediment to animal movement along the race.

Further, this concept may be extended by using one or more projections, curves or other features causing animal movement in the horizontal plane. Such features can be used to cause movement of animal identification devices into closer proximity to one or more ID readers positioned on the opposing walls of the race 2, such as readers 5 in FIG. 1.

The Applicant has also found that the performance of ID reader systems can be improved by use of a race structure that encourages a smoother or more regulated flow of animals through the race. This decreases the number of identification devices that are simultaneously presented to individual readers, thereby improving read quality, as well as increasing the usability of the system as a whole.

In particular, the Applicant has found that undulating race walls tend to cause animals both to self-sort at the entrance to the race and also to flow relatively smoothly and evenly spaced from each other through the race itself. This can be contrasted with prior races having straight walls, where the animals tend to bunch together at the entrance, creating a bottle neck, and tend not to flow evenly along the race.

In some embodiments the Applicant's undulating walls are sufficiently widely spaced that animals can follow a straight path along the race between the undulating walls. Particularly for sheep races the walls may be sufficiently widely spaces that animals can pass along the race on a straight path two abreast. In other embodiments the undulating walls may define an undulating path, where some sideways movement of the animal is required as it passes through the race.

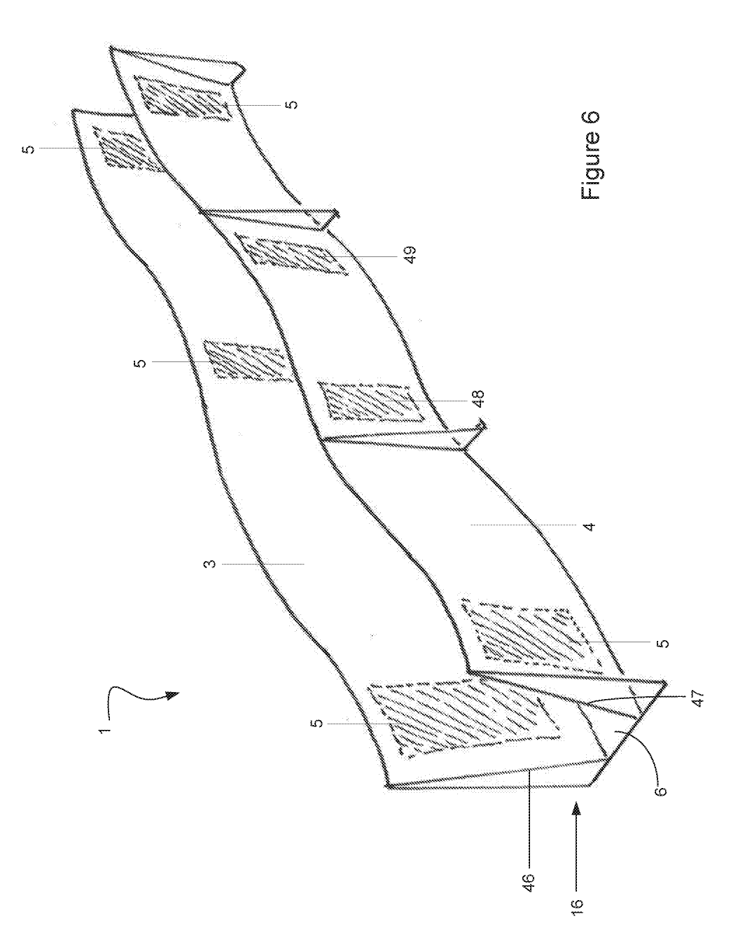

FIG. 6 shows one embodiment of animal identification system 1, in which the opposing walls 3, 4 are both undulating walls having a relatively smooth wave-like form. In this embodiment the opposing walls 3, 4 are also at an angle to the vertical, as is clear from the ends 46, 47 of the two walls 3, 4 at the entrance 16 of the race 2. The race is therefore somewhat wider at the top than it is at the level of the floor 6. This is also believed to aid the regulated flow of animals through the race. The range of angles of the walls may range from 10 to 25 degrees from a vertical axis. Other angles may be suitable for some applications.

In the embodiment of FIG. 6, a number of ID readers 5 are positioned on the outside of the opposing walls 3, 4. Further, at least some of these readers may be positioned at different points on the undulations of the walls 3, 4, such that they will not all be at the same angle. This can be most clearly seen by comparison between ID readers 48, 49. Again, this provides improved diversity in the read system, with the ID readers collectively more likely to pick up signals from animal identification devices moving along the race 2.

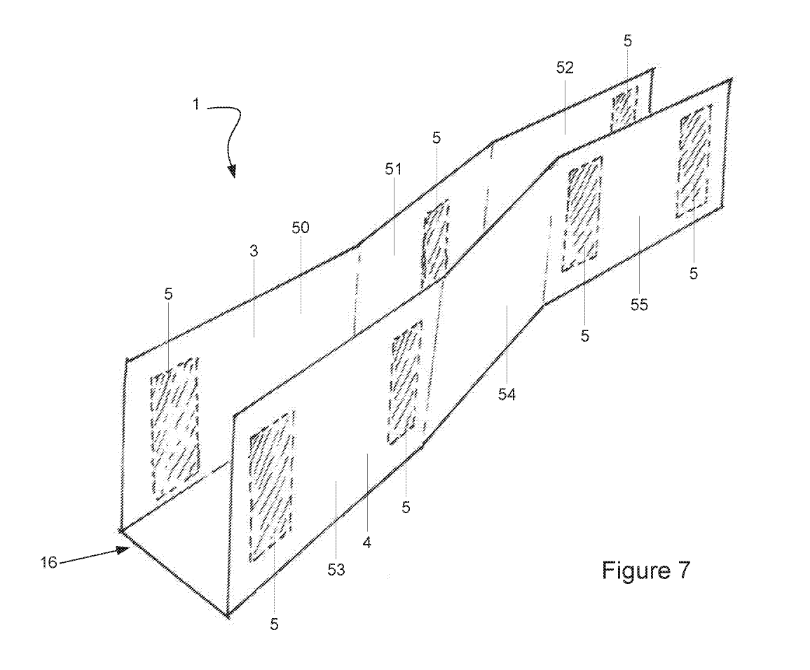

FIG. 7 shows a further embodiment of animal identification system 1, in which the opposing walls 3, 4 are both undulating walls formed by a number of planar sections at an angle to each other. A first opposing wall 3 includes generally planar wall sections 50, 51, 52 and a second opposing wall 4 includes generally planar wall sections 53, 54, 55.

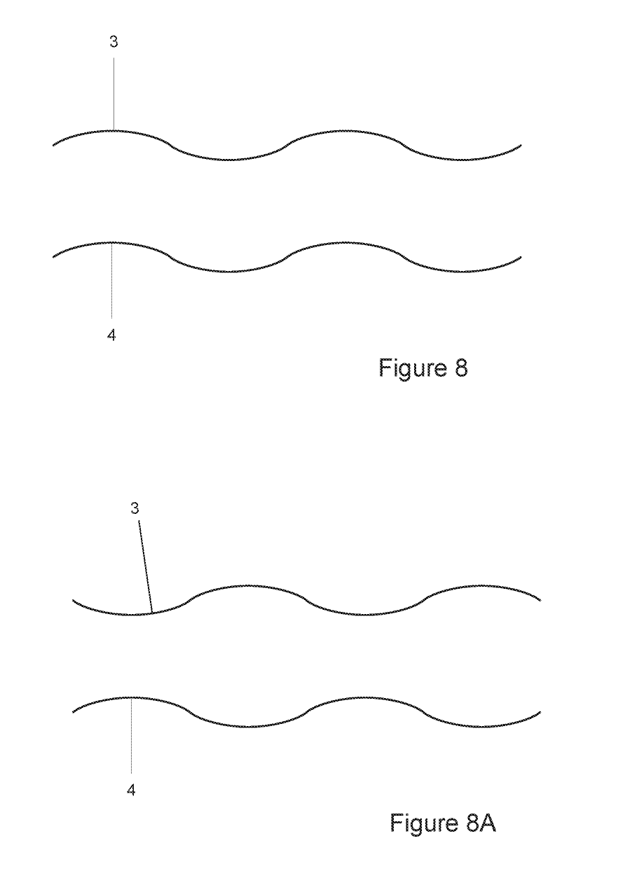

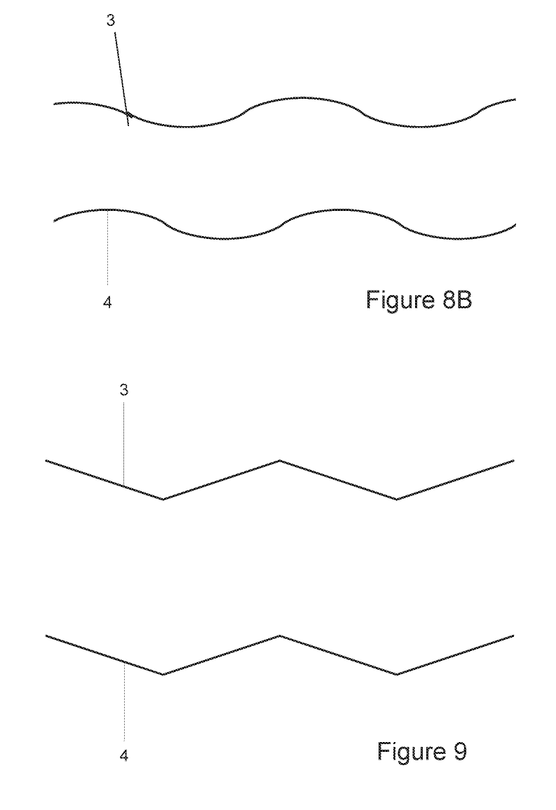

FIGS. 8 to 13 each show a possible undulating wall profile, viewed from the top. Any undulating wall profile may, if desired, be arranged at an angle to the vertical to define a race narrower at floor or ground level than at its top surface. Note that, in some embodiments, the two walls do not need to be parallel or “in phase” with each other.

FIG. 8 shows opposing walls 3, 4, which are both undulating walls having a relatively smooth wave-like form, similar to the walls of FIG. 6. These walls are generally S-shaped and define a generally S-shaped race 2.

FIG. 8A shows opposing walls 3, 4, which are both undulating walls having a relatively smooth wave-like form, similar to the walls of FIG. 6. These walls are generally S-shaped but are offset and define a race with an undulating width.

FIG. 8B shows opposing walls 3, 4, which are both undulating walls having a relatively smooth wave-like form, similar to the walls of FIG. 6. These walls are generally S-shaped and define a generally S-shaped race 2. These walls are somewhat offset from each other, but not to the extent of FIG. 8A.

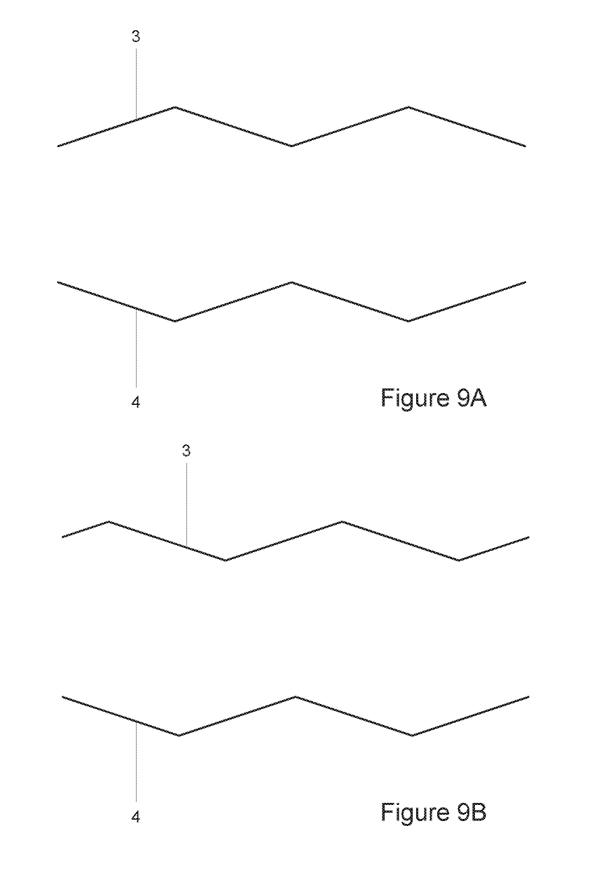

FIG. 9 shows opposing walls 3, 4, which are both undulating walls formed by a number of planar sections arranged at an angle to each other, similar to the walls of FIG. 7. These walls are generally W-shaped and define a generally W-shaped race 2.

FIG. 9A shows opposing walls 3, 4, which are both undulating walls formed by a number of planar sections arranged at an angle to each other, similar to the walls of FIG. 7. These walls are generally W-shaped but are offset and define a race with an undulating width.

FIG. 9B shows opposing walls 3, 4, which are both undulating walls formed by a number of planar sections arranged at an angle to each other, similar to the walls of FIG. 7. These walls are generally W-shaped and define a generally W-shaped race 2. These walls are somewhat offset from each other, but not to the extent of FIG. 9A.

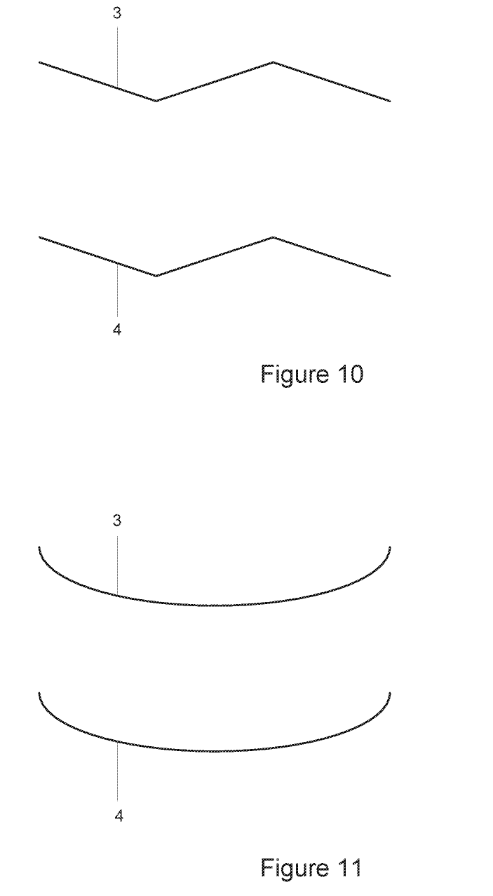

FIG. 10 shows opposing walls 3, 4, which are also both undulating walls formed by a number of planar sections arranged at an angle to each other, similar to the walls of FIG. 7. These walls are generally Z-shaped and define a generally Z-shaped race 2.

FIG. 11 shows opposing walls 3, 4, which are both undulating walls having a relatively smooth wave-like form, similar to the walls of FIG. 6. These walls are generally U-shaped and define a generally U-shaped race 2.

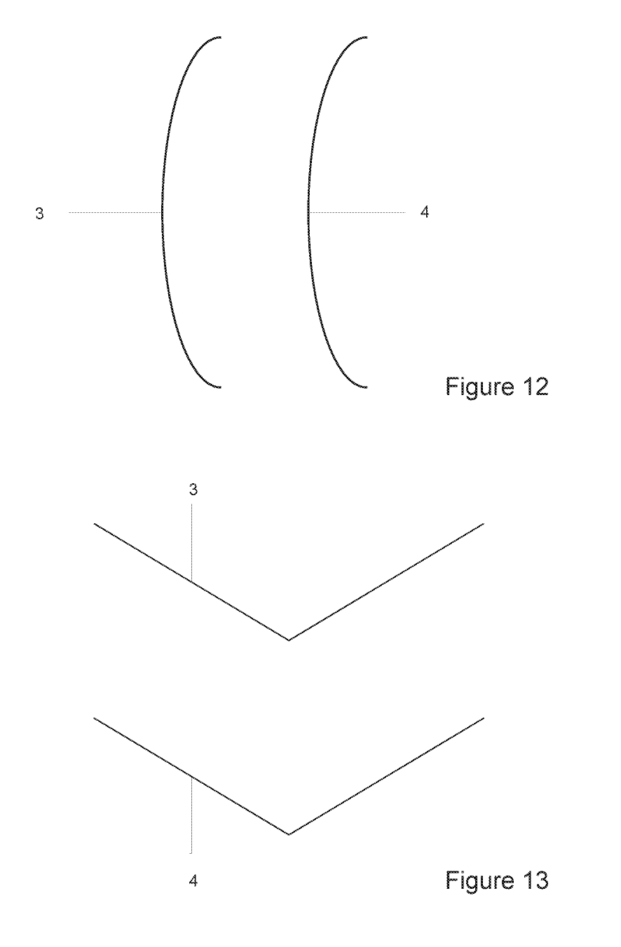

FIG. 12 shows opposing walls 3, 4, which are both undulating walls having a relatively smooth wave-like form, similar to the walls of FIG. 6. These walls are generally C-shaped and define a generally C-shaped race 2.

FIG. 13 shows opposing walls 3, 4, which are also both undulating walls formed by a number of planar sections arranged at an angle to each other, similar to the walls of FIG. 7. These walls are generally V-shaped and define a generally V-shaped race 2.

As with the generally S or W shaped walls of FIGS. 8 to 8B and 9 to 9B, the generally Z, U, C or V shaped walls of FIGS. 10 to 13 may be parallel or in phase (as shown in FIGS. 10 to 13) or may be offset from each other or out of phase.

As is clear from the above example, the terms “undulation” and “undulating” are used in this specification to refer to curved or angled surfaces. Surfaces defining a single curved or angled change of direction, such as the U, C or V shaped walls of FIGS. 11 to 13 include a single undulation. Surfaces defining two curved or angled changes of direction, such as the Z shaped walls of FIG. 10, include two undulations. The W shaped walls of FIG. 9 define three undulations and the S shaped walls shown in FIG. 8 define 4 undulations.

Preferred embodiments include walls defining two or more undulations. However in some embodiments walls having single undulations may be used.

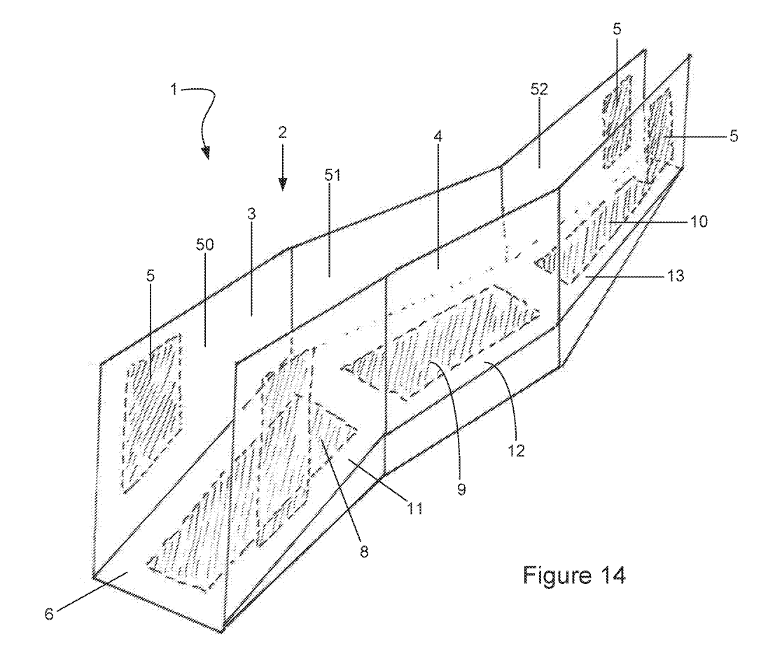

FIG. 14 shows a further embodiment of identification system including a floor profile with a height change and an undulating wall profile. The floor profile of FIG. 14 is a ramp structure similar to that of FIGS. 1 and 2. The wall profile is a generally Z-shaped profile similar to that of FIGS. 7 and 10. This embodiment provides still further improvements in read performance. The undulating walls 3, 4 promote smooth rapid flow of animals through the race 2. Further, the quality of reads is improved by the floor structure, which tends to cause animals to bring their heads (and therefore identification devices borne on their heads) into closer proximity to at least one of the readers 8, 9, 10 positioned beneath the floor 6. Further, the readers 5, 8, 9, 10 are mounted at various angles to the animal path, being mounted on the sloping and flat sections 11, 12, 13 of the floor as well as on various angled sections of the walls 3, 4. This diversity of ID reader orientation improves read quality.

In general any suitable floor profile defining a slope, step or height change (including any of the profiles shown in FIGS. 1 to 5) may be used together with any suitable undulating wall profile (including any of the profiles shown in FIGS. 6 to 13).

The length of the race 2 may vary depending upon species and the style of undulation employed. For example a C-shaped race may be relatively short (around 1-2 metres) where as a Z or S shaped race may be more than 2 metres, around 2 to 5 metres in length. In other embodiments the race may be more than 4 metres in length.

The length of each undulation may also depend upon species and style of undulation. However, typically each undulation may be around 0.5 to 2 times the average body length of the typical animal of the desired species, preferably around 0.7 to 1.5 times the average body length of the typical animal of the desired species, more preferably approximately equal to the average body length of the typical animal of the desired species.

When viewed from above, the distance from the inside to the outside of each undulation could vary depending upon the use of angled walls as described above, but typically will be around 1 to 2.5, preferably around 1.5 to 2, more preferably around 1.75 times the average width of an average animal in a given species at shoulder height. As an example, shorn sheep are usually on average around 350 mm wide—so the undulations may be around 1.75×350 mm, or approximately 600 mm deep.

The animal race may have a height suited to the species in question. For sheep and other small stock the height may be around 1 metre, while for cattle, deer, etc the race may be around 1.8 metres or more in height.

The Applicant's reader systems may be used with any suitable reader technology, including low frequency and ultra high frequency (UHF) readers.

The Applicant's reader systems may also be used with any suitable type of animal identification device, including ear tags, anklets, intra-ruminal devices, implants, or similar devices. The animal identifications devices are capable of emitting an identification signal, and may rely on any suitable identification technology, including RFID (radio frequency identification), and other electronic identification technologies. The identification devices may be any suitable devices, including implants, ear tags, boluses, anklet devices etc.

The Applicant's race structure may be installed permanently in animal yards etc. Alternatively the race structure may be provided in a mobile form, for example as a number of modules or interlocking elements that can be dismantled for transport. The race structure should be formed from a material that does not interfere with the functioning of the read system. Preferably the race is formed from timber, plywood or similar, or more preferably from plastic materials. The race structure may be moulded from suitable plastics such as any suitable thermoplastic, or moulded rubber, or timber hybrid, or composite material.

In use, the Applicant's systems may be used in conjunction with any suitable yards, races, drafting systems or other barriers suitable for introducing animals to the entrance of the race 2 and for directing flow of animals after exiting the race 2.

Any of the above embodiments may be free of overhead structures, such as the beams, overhead antenna structures and the like used in some prior systems. Any of the above embodiments may be adapted if necessary such that the opposing walls 3, 4 are at an angle to the vertical, to form a race is therefore somewhat wider at the top than it is at the level of the floor 6.

While the present invention has been illustrated by the description of the embodiments thereof, and while the embodiments have been described in detail, it is not the intention of the Applicant to restrict or in any way limit the scope of the appended claims to such detail. Further, the above embodiments may be implemented individually, or may be combined where compatible. Additional advantages and modifications, including combinations of the above embodiments, will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. An animal identification system, including:
i. a race including a pair of opposed walls between which, in use, animals pass, and a floor including one or more steps or sloping sections defining a height change;
ii. one or more readers configured to read electronic animal identification devices borne by animals passing along the race;
wherein, at least one of the one or more readers is positioned beneath, on top of or within the floor at or near the height change such that, in use, movement of the animals caused by the height change tends to bring the animals' identification devices into closer proximity to that reader.

2. An animal identification system as claimed in claim 1 wherein the height change is defined by an upwardly sloping ramp.

3. An animal identification system as claimed in any preceding claim wherein the animal identification devices are borne by the animals' heads and the height change causes animals to drop their heads.

4. An animal identification system as claimed in any preceding claim including at least two readers positioned beneath, on top of or within the floor and being oriented at different angles with respect to a vertical plane.

5. An animal identification system, including:
i. a race including a pair of opposed walls between which, in use, animals pass; and
ii. one or more readers configured to read electronic animal identification devices borne by animals passing along the race;
wherein the race has a structure that causes animals to move within the race such that identification devices borne by the animals are moved in a non-linear manner through the race, this non-linear movement tending to bring the animals' animal identification devices into closer proximity to at least one of the one or more readers.

6. An animal identification system as claimed in claim 5 wherein the at least one of the one or more readers is positioned on one of the opposed walls and the race structure is configured to cause sideways movement of the animals as they pass along the race.

7. An animal identification system as claimed in claim 6 wherein the race structure includes one or more includes one or more projections, curves or undulations configured to cause the sideways movement.

8. An animal identification system as claimed in claim 6 or 7 wherein the animal identification devices are borne by the animals' heads and the sideways movement is sideways movement of the animals' heads.

9. An animal identification system as claimed in claim 5 wherein the race structure includes one or more includes one or more steps or sloping sections defining a height change, configured to cause vertical movement of the animal's heads as they pass along the race.

10. An animal identification system as claimed in claim 9 wherein at least one of the one or more readers is positioned beneath, on top of or within the floor at or near the height change such that, in use, movement of the animals caused by the height change tends to bring the animals' identification devices into closer proximity to that reader.

11. An animal identification system as claimed in claim 9 or 10 wherein the height change is defined by an upwardly sloping ramp.

12. An animal identification system as claimed in any one of claims 9 to 11 wherein the animal identification devices are borne by the animals' heads and the height change causes animals to drop their heads.

13. An animal identification system as claimed in any one of claims 9 to 12 including at least two readers positioned beneath, on top of or within the floor and being oriented at different angles.

14. An animal identification system as claimed in any preceding claim wherein the pair of opposed walls define one or more undulations.

15. An animal identification system as claimed in claim 14 wherein the pair of opposed side walls define a single undulation.

16. An animal identification system as claimed in claim 15 wherein the race has a generally U, C or V shape.

17. An animal identification system as claimed in claim 14 wherein the pair of opposed side walls define two or more undulations.

18. An animal identification system as claimed in claim 17 wherein the race has a generally S, Z or W shape.

19. An animal identification system as claimed in any one of claims 14, 15 or 17 wherein the undulations define a continuous curved surface.

20. An animal identification system as claimed in any one of claims 14, 15 or 17 wherein the undulations define a discontinuous surface with a number of substantially planar sections arranged at an angle to each other.

21. An animal identification system as claimed in any one of claims 14 to 20 wherein the length of each undulation is between 0.5 and 2 times the average body length of the animals to be identified.

22. An animal identification system as claimed in any one of claims 14 to 21 wherein the length of each undulation is between 0.7 and 1.5 times the average body length of the animals to be identified.

23. An animal identification system including:
i. a race including a pair of opposed walls between which, in use, animals pass, the pair of opposed walls defining one or more undulations; and
ii. a plurality of ID readers positioned to read animal ID devices borne by animals passing along the path.

24. An animal identification system as claimed in claim 23 wherein the pair of opposed side walls define a single undulation.

25. An animal identification system as claimed in claim 24 wherein the race has a generally U, C or V shape.

26. An animal identification system as claimed in claim 23 wherein the pair of opposed side walls define two or more undulations.

27. An animal identification system as claimed in claim 26 wherein the race has a generally S, Z or W shape.

28. An animal identification system as claimed in any one of claims 23, 24 or 26 wherein the undulations define a continuous curved surface.

29. An animal identification system as claimed in any one of claims 23, 24 or 26 wherein the undulations define a discontinuous surface with a number of substantially planar sections arranged at an angle to each other.

30. An animal identification system as claimed in any one of claims 23 to 29 wherein the length of each undulation is between 0.5 and 2 times the average body length of the animals to be identified.

31. An animal identification system as claimed in any one of claims 23 to 30 wherein the length of each undulation is between 0.7 and 1.5 times the average body length of the animals to be identified.

32. An animal identification system, including:
i. a race including a pair of opposed walls defining a path along which, in use, animals pass;
ii. one or more readers configured to read electronic animal identification devices borne by animals passing along the path through the race;
wherein the opposed walls include at least one angled wall portion that is non-parallel with the path, and wherein at least one reader is mounted on the angled wall portion such that the reader is positioned at an acute angle to the path.

33. An animal identification system as claimed in any preceding claim wherein the race is at least 1.5 metres in length.

34. An animal identification system as claimed in any preceding claim wherein the race is at least 2.5 metres in length.

35. An animal identification system as claimed in any preceding claim wherein the opposing walls are arranged at an angle to the ground, such that the race is narrower at ground level than at a higher point.

36. An animal identification system as claimed in any preceding claim wherein at least some of the ID readers are positioned on the opposing walls.

37. An animal identification system as claimed in any preceding claim wherein at least some of the ID readers are oriented at different angles to each other.

38. An animal identification system as claimed in any preceding claim wherein the animal identification devices are ear tags.

39. An animal identification system as claimed in any one of claims 1 to 37 wherein the animal identification devices are animal intra-ruminal devices, implants, or similar devices.
